(19) United States
(12) Patent Application Publication
(10) Pub. No.: US 2005/0200954 A1
(43) Pub. Date: Sep. 15, 2005

(54) Transmissive screen and display device

(76) Inventors: Hideto Yamashita, Suwa (JP); Nobuo Shimizu, Suwa (JP)

Correspondence Address: HARNESS, DICKEY & PIERCE, P.L.C., P.O. BOX 828, BLOOMFIELD HILLS, MI, 48303, US

(21) Appl. No.: 11/075,156

(22) Filed: Mar. 8, 2005

(30) Foreign Application Priority Data
Mar. 12, 2004 (JP) 2004-070223
Feb. 17, 2005 (JP) 2005-040608

(51) Int. Cl. G03B 21/56

(52) U.S. Cl. 359/460

(57) ABSTRACT

Provided is a transmissive screen and display device capable of seeking an improved contrast with a simple structure. This transmissive screen comprises a light-permeable sheet in which the thickness on the incident light side is 2 Å or more and 5 μm or less and a colored layer having an OD value of 0.2 or more is provided thereto. Preferably, the OD value is 0.3 to 3.0, and, preferably, the thickness of the colored layer is 3 μm or less. The light-permeable sheet, for example, may be formed from polycarbonate or acrylic resin.

### BACKGROUND OF THE INVENTION

1. Field of the Invention

The present invention relates to a transmissive screen and display device capable of seeking an improved contrast with a simple structure.

2. Description of the Related Art

Conventionally, a rear projector for projecting images from its rear face onto a transmissive projection screen, which employs a CRT (cathode-ray-tube) as the picture source, is known.

With this kind of rear projector, it is necessary to suppress the reflection of outside light while suppressing the deterioration of the intensity of light in order to improve the contrast.

For example, in order to attain the foregoing object, Japanese Patent No. 3335588 (Patent Document 1) discloses a transmissive screen in which a colored layer is provided to the light entrance face of a lenticular lens, and the pitch of the lens portion of the lenticular lens and the thickness of the colored layer are set to be within a prescribed range. Further disclosed is a transmissive screen in which the thickness of the colored layer is prescribed with the cross section shape of the lenticular lens.

Nevertheless, with the transmissive screen described in Patent 1, a favorable colored layer thickness was set forth based on the relationship with the lens pitch. Further, there was still margin for improving the contrast.

### SUMMARY OF THE INVENTION

Thus, an object of the present invention is to provide a transmissive screen and display device capable of seeking an improved contrast with a simple structure.

Under the foregoing circumstances, as a result of intense study, the present inventors discovered that a transmissive screen superior in contrast could be provided by setting the density and thickness of the colored layer to be within a prescribed range without limitation to the surface shape of the light-permeable sheet, and arrived at devising the present invention.

In order to achieve the foregoing object, the present invention provides a transmissive screen comprising a light-permeable sheet in which the thickness on the incident light side is 2 Å (angstrom) or more and 5 μm or less and a colored layer having an OD value of 0.2 or more, preferably 0.3 to 3.0, is provided thereto.

According to the present invention, by setting to the density and thickness of the colored layer provided to the incident light side to be within a prescribed range, a transmissive screen having a favorable contrast can be obtained. Therefore, the present invention can be easily employed in transmissive screens of various shapes, and a complex design will not be required upon designing the colored layer. Further, according to this constitution, as a result of setting the optical density (OD value) of the colored layer provided to the incident light side to be within a prescribed range, a transmissive screen superior in contrast can be obtained. Therefore, the present invention can be easily employed in transmissive screens of various shapes, and a complex design will not be required upon designing the colored layer. Here, contrast means the contrast (white luminance/black luminance) of the transmissivity (white luminance) of light generated from the light source, and the reflectivity (black luminance) of light (outside light) entering from the outside.

It is desirable that the thickness of the colored layer is 2 Å or more and 3 μm or less. The contrast will be even more superior when the thickness of the colored layer is within the foregoing range.

Preferably, the light-permeable sheet is formed from polycarbonate or acrylic resin. As a result of using this kind of resin, the transparency, workability and mechanical strength will be superior.

Preferably, the coloring agent employed in the colored layer is dye. Since dye is soluble in a solvent, the dispersibility is favorable, the density of the colored layer can be adjusted easily to be approximately uniform, and the manufacture of the transmissive screen can thereby be facilitated.

Even when the light-permeable sheet is a microlens array sheet in which a plurality of convex microlenses is formed on the incident light side, a favorable contrast can be obtained. According to the constitution of the present invention, since a favorable contrast can be obtained regardless of the constitution (shape) of the surface of the light-permeable sheet, a microlens array sheet having a complex constitution can also be manufactured easily. Therefore, it is possible to yield viewing angle control characteristics in an arbitrary direction, and a transmissive screen having a favorable contrast can be obtained thereby.

Both sides of the light-permeable sheet may be approximately flat. A favorable contrast can also be obtained even with this kind of constitution.

In another embodiment of the present invention, provided is a display device employing the transmissive screen described above. As a result, a display device having a favorable contrast can be provided.

Here, an example of such display device would be a rear transmissive display device.

### BRIEF DESCRIPTION OF DRAWINGS

FIG. 1 is a diagram for explaining an example of the transmissive screen of the present invention;

FIG. 2 is a diagram for explaining the light-permeable sheet employed in the present invention;

FIG. 3 is a diagram showing a modified example of the light-permeable sheet employed in the present invention;

FIG. 4 is a diagram for explaining the rear transmissive image display device as an example of the display device according to the present invention;

FIG. 5 is a graph showing the measurement result of the contrast in relation to the transmissivity in the light room 1;

FIG. 6 is a graph showing the measurement result of the contrast in relation to the transmissivity in the light room 2; and

FIG. 7 is a diagram for explaining the light-permeable sheet 10b as a comparative example.

### DETAILED DESCRIPTION OF THE PREFERRED EMBODIMENTS

### First Embodiment

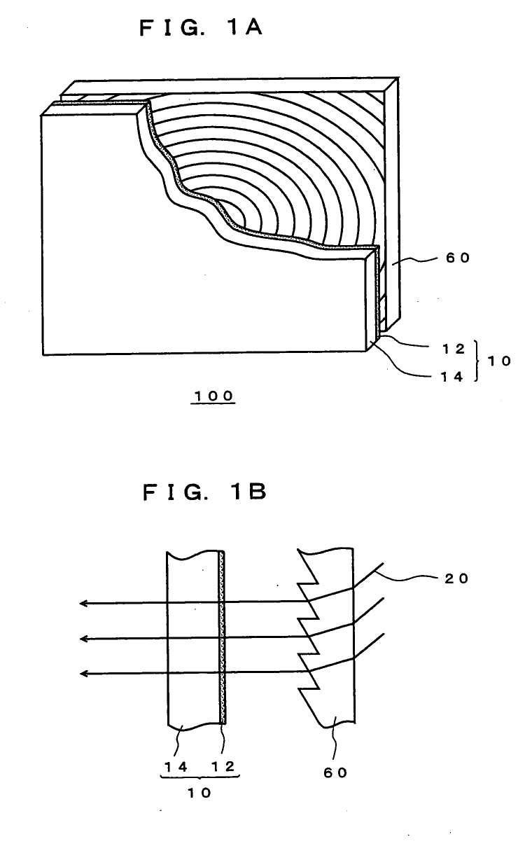

FIG. 1 is a diagram for explaining an example of the transmissive screen of the present invention.

As shown in FIG. 1(A), a transmissive screen 100 is constituted by including a Fresnel lens 60 from the incident light side, and a light-permeable sheet 10 comprising a colored layer 12 provided to the face to which light enters from the light source (not shown).

FIG. 1(B) is a diagram for explaining the path of the incident light from the light source. The light 20 entering unidirectionally becomes parallel light at the Fresnel lens 60, thereafter passes through the light-permeable sheet 10 comprising the colored layer 12, and is then diffused and emitted outward.

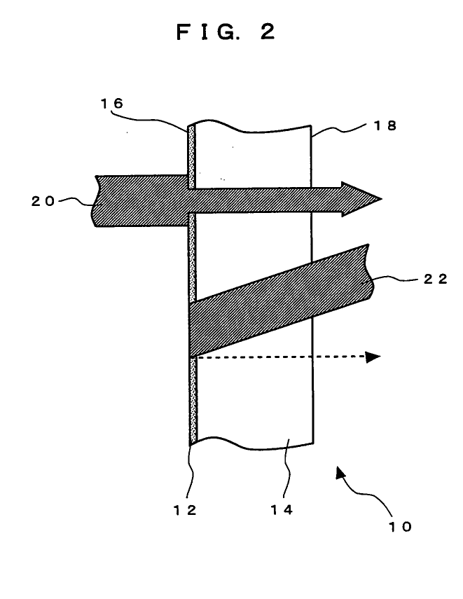

FIG. 2 is a diagram for explaining the light-permeable sheet 10 employed in the present invention.

As shown in FIG. 2, the light-permeable sheet 10 comprises the colored layer 12 at the entrance plane 16 to which light 20 from the light source (not shown) enters. In the present embodiment, the surface of the light-permeable sheet 10 is approximately flat in both the entrance plane 16 and exit plane 18.

The light-permeable sheet 10 is formed from a light-permeable material capable of permeating light. As this kind of light-permeable material, resin is preferably used from the perspective of mechanical strength and workability. In particular, from the perspective of high transparency, polycarbonate or acrylic resin (e.g., polymethyl methacrylate) is preferably used. Moreover, as necessary, a diffusing agent may be mixed in the resin for forming the light-permeable sheet 10. This kind of diffusing agent is used for diffusing the incident light 20 from the light source, and, for instance, glass beads, polyethylene beads, organic cross-linked polymer and the like may be used. Such diffusing agent may be mixed with the overall resin, or may be mixed with only a portion thereof. For example, when there is a large quantity of diffusing agent on the side of the exit plane 18, the outside light 22 will be diffused before reaching the colored layer 12, and will exit as reflected light. Thus, in the vicinity of the exit plane 18, it is preferable that the density of the diffusing agent is made low. Therefore, the density gradient may be set such that the density of the diffusing agent will become lower from the entrance plane 16 toward the exit plane 18, or a diffusion layer may be provided only to the side of the entrance plane 16. Although there is no particular limitation on the density of the diffusing agent so as long as it is able to achieve the object of the present invention, for instance, 0.1 to 10 parts by weight of the diffusing agent is added to 100 parts by weight of resin.

Although there is no particular limitation on the thickness of the light-permeable sheet 10 so as long as it is able to achieve the object of the present invention, from the perspective of strength, resolution and visibility, for instance, the thickness is made to be 1 to 3 mm. Further, although there is also no particular limitation on the haze (haze: Td/Tt, Td: transmissivity of diffused beam; Tt: transmissivity of all beams) of the transmissive sheet 10 so as long as it is able to attain the object of the present invention, from the perspective of viewing angle characteristics, for instance, it is preferably around 30 to 99%.

The colored layer 12 is colored with a coloring agent such as a dye or pigment. In particular, when dye is used as the coloring agent, since it can be dissolved in an arbitrary solvent, the dispersibility will be favorable, and the density of the colored layer can be adjusted easily to become approximately uniform. Further, this is preferable since the colored layer 12 can be easily manufactured to have a desired thickness by immersing it into a solution with the coloring agent dissolved therein and adjusting the immersion time. As the coloring agent, for example, an achromatic color such as gray, or a color that is capable of selectively absorbing or permeating light having a specific wavelength for controlling the balance of the three primary colors (R (red), G (green), B (blue)) of the light source not shown may be used.

In the present invention, a stain solution containing a phenylphenol compound as the disperse dye, anionic surface-active agent and carrier is used to stain the synthetic resin. As examples of a reactive dye employed as the colored component, as disclosed in the likes of Senryo Binran (Hanbook on Dyes) (edited by The Society of Synthetic Organic Chemistry, Japan, Maruzen (1970), page 880), (1) dye having a chlor-triazinyl base, (2) dye having a vinyl sulfone base, and (3) dye having an alkyl sulfuric acid base may be considered. Specifically, C.I. Reactive Blue 19, C.I. Reactive Blue 27, C.I. Reactive Blue 28, C.I. Reactive Violet 5, C.I. Reactive Black 5, C.I. Reactive Black 14 and the like may be considered. The thickness of the colored layer 12, so as long as it is able to retain the concentration of the colored layer 12 described layer, will be able to obtain a favorable contrast when the coloring agent of the colored component is mixed into a monolayer resin. Since the size of a single molecule of a general coloring agent is roughly 2 angstrom, it is desirable that the thickness of the colored layer 12 is 2 Å or more and 5 μm or less, preferably 2 Å or more and 3 μm or less. The thinner the thickness of the colored layer 12, the contrast tends to be more superior, so as long as it is able to retain the density of the colored layer 12 as described later. When the thickness of the colored layer 12 is within the foregoing range, the balance of the transmissivity of the incident light 20 and the reflectivity of the outside light 22 will be superior. In other words, the contrast will become favorable since the reflection of the light (outside light) 22 entering into the light-permeable sheet 10 from the outside can be suppressed without significantly deteriorating the transmissivity of the incident light 20 from the light source not shown.

Further, the OD value of the light-permeable sheet 10 is 0.2 or more, and more preferably 0.3 to 3.0. According to this constitution, as a result of setting the optical density (OD value) of the colored layer provided to the incident light side to be within the foregoing range, a transmissive screen superior in contrast can be obtained. Therefore, the present invention can be easily employed in transmissive screens of various shapes, and a complex design will not be required upon designing the colored layer. Moreover, the balance of brightness and contrast under a bright environment will be superior.

Further, it is preferable that the layer (base material layer 14) on the side of the exit plane 18 is not colored, or, if it is colored, that it is of a lower density than the colored layer 12 of the light-permeable sheet 10. In other words, it is preferable that the foregoing OD value is achieved with the colored layer 12. When the base material layer 14 is colored, the transmission efficiency of the incident light 20 tends to deteriorate, and, by adopting the foregoing constitution, reflection of the outside light 22 can be reduced without significantly deteriorating the transmissivity of the incident light 20 from the light source.

### MODIFIED EXAMPLE 1

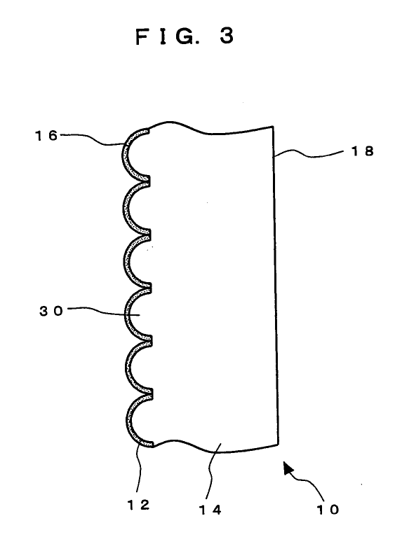

FIG. 3 is a diagram showing a modified example of the light-permeable sheet employed in the present invention.

In the first embodiment, although an approximately flat sheet was used as the surface of the light-permeable sheet 10, as shown in FIG. 3, a microlens array sheet in which a plurality of convex microlenses 30 is formed two-dimensionally to the entrance plane 16 may also be used. There is no particular limitation on the planar shape of the microlens 30, and, for example, it may be an approximate circular shape or an approximate oval shape.

Even when a plurality of microlenses 30 is formed on the surface as described above, as a result of setting the thickness of the colored layer 12 to be within the range indicated in the foregoing embodiment, a favorable contrast can be obtained without having to depend on the lens pitch. Further, as a result of employing a microlens array sheet, it is possible to yield viewing angle characteristics in an arbitrary direction, and a transmissive screen 200 having a superior viewing angle and favorable contrast can be obtained.

Incidentally, for example, this type of microlens array sheet may be used in place of the light-permeable sheet 10 illustrated in FIG. 1(A) for obtaining the transmissive screen 100 having superior viewing angle characteristics.

(Display Device)

The transmissive screen 100 of the present invention may be suitably employed in a display device (electro-optic device) such as a projector. As this kind of display device, for instance, a rear transmissive image display device (e.g., rear projection TV) may be considered.

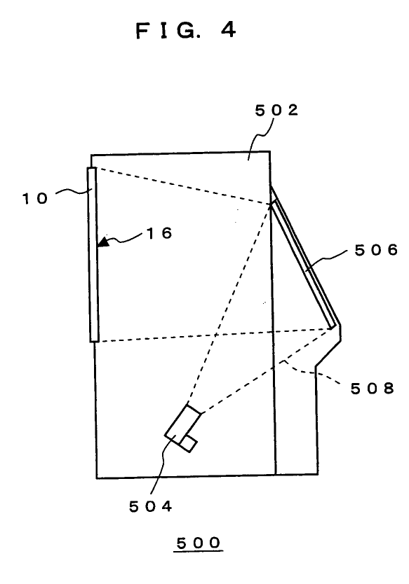

FIG. 4 is a diagram for explaining the rear transmissive image display device as an example of the display device according to the present invention. As shown in FIG. 4, the rear transmissive image display device 500 comprises an image projection device (e.g., projection-type CRT, liquid crystal, etc.) 504 in a case (cabinet) 502. The opening at the back part of the case 502 is covered with a mirror cover, and a reflecting mirror 506 is disposed inside this mirror cover. A rectangular opening is formed at the front face of this case 502, and the transmissive screen 100 is provided thereto such that the colored layer 12 on the incident light side faces the face 16. The image light 508 projected from the image projection device 504 is reflected at the reflecting mirror 506, and thereafter projected on to the light-permeable sheet 10 as the transmissive screen.

As described above, by using the transmissive screen of the present invention, a display device having a favorable contrast can be provided.

### EXAMPLES

The present invention is now explained in further detail with reference to the Examples.

### Example 1

A PMMA resin (methacrylic resin) was used as the molding resin to form a light-permeable sheet 10 in which the thickness of the colored layer is approximately 3 μm, the thickness of the overall sheet is 1 mm, which has various optical densities, and both sides (entrance plane 16 and exit plane 18) thereof being approximately flat. Here, as the coloring agent for forming the colored layer 12, FSP (product name) manufactured by Futaba Sangyo K.K. was used. The density of the coloring agent was set to 1.48 g/L by diluting the coloring agent in water. Further, the thickness of the colored layer was adjusted by adjusting the time the colored layer 12 was immersed in the coloring agent. As a result, eight light-permeable sheets 10 in which the transmissivity I/I₀ (I: exiting light; I₀: incident light) is between roughly 30 to 95% (32.3%, 42.8%, 50.6%, 66.6%, 74.8%, 78.4%, 86.0% and 94.58%) were obtained. Here, upon molding all of the light-permeable sheets 10, 2 parts by weight of polyethylene beads as the diffusing agent in relation to 100 parts by weight of the molding resin was mixed to the overall molding resin. The haze at such time was all roughly 70%.

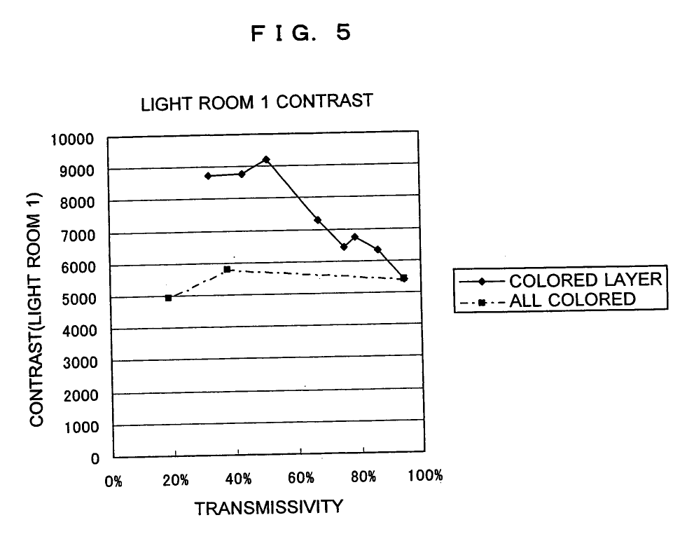

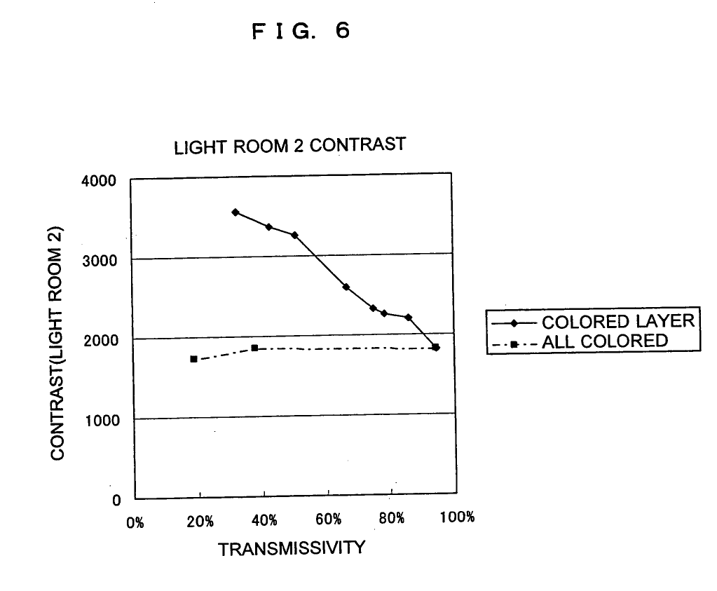

For each of the light-permeable sheets 10 formed above, the contrast in a light room 1 and light room 2 was measured according to the following method. The results are shown in FIG. 5 and FIG. 6.

### Comparative Example 1

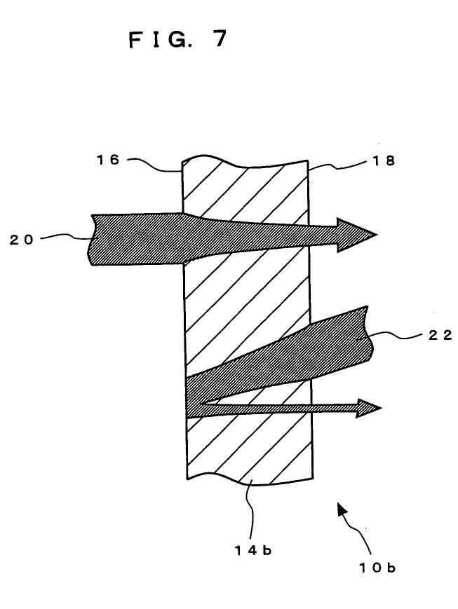

FIG. 7 is a diagram for explaining the light-permeable sheet 10b as a comparative example. In FIG. 7, the constituent elements corresponding to those depicted in FIG. 2 are given the same reference numeral, and the explanation thereof is omitted. As shown in FIG. 7, a light-permeable sheet 10b was formed in which the overall base material layer 14b has been colored. As the method of molding, the light-permeable sheet 10b was formed upon mixing the coloring agent to the overall molding resin in advance. As a result of changing the density of the mixed coloring agent, three transmissive sheets 10b were formed. The transmissivity I/I₀ of the obtained light-permeable sheet 10b was 19.1%, 37.9% and 94.6%.

For each of the light-permeable sheets 10b formed above, the contrast in a light room 1 and light room 2 was measured according to the following method. The results are shown in FIG. 5 and FIG. 6.

(Testing Method)

A light-permeable sheet prepared as describe above was combined with a Fresnel lens to form a transmissive screen, a rear transmissive image display device illustrated in FIG. 4 was constituted thereby, and the contrast in a bright room (light room) was measured.

As the contrast (CNT), the ratio LW/LB of the front luminance (white luminance) LW (cd/m²) of the white display upon entrance of all white light of 413lx in a dark room, and the increase (increase of black luminance) LB (cd/m²) of the front luminance of the black display upon all light sources being turned off in a light room was sought. Incidentally, the increase of black luminance is the increase in relation to the luminance of the black display in a dark room.

Two light rooms were used for the measurement; namely, a room in which the luminance of outside light is approximately 65lx (light room 1), and a room in which the luminance of outside light is approximately 185lx (light room 2). Incidentally, FIG. 5 is a graph showing the measurement result of the contrast in relation to the transmissivity in the light room 1, and FIG. 6 is a graph showing the measurement result of the contrast in relation to the transmissivity in the light room 2.

From the comparison of data of Example 1 and Comparative Example 1 shown in FIG. 5 and FIG. 6, when the transmissivity is lower than approximately 95%, at the same transmissivity, the contrast will improve when the thickness of the colored layer is made thin compared to when the overall sheet is colored. Further, when the overall sheet is colored, there is hardly any change in the contrast regardless of the transmissivity. Nevertheless, when the thickness of the colored layer is made extremely thin, and the density of the colored density is made dense as with the present invention, the contrast will change depending on the transmissivity.

Further, from the data of Comparative Example 1, when the thickness of the colored layer 12 is thick, the contrast deteriorated.

As described above, it has been shown that the contrast CNT depends on the transmissivity of the light-permeable sheet 10 and the thickness of the colored layer 12, and, lower the transmissivity (higher the optical density) and thinner the thickness of the colored layer 12, the contrast will improve.

1. A transmissive screen comprising a light-permeable sheet in which the thickness on the incident light side is 2 Å or more and 5 μm or less and a colored layer having an OD value of 0.2 or more is provided thereto.

2. A transmissive screen according to claim 1, wherein said OD value is 0.3 to 3.0.

3. A transmissive screen according to claim 1, wherein the thickness of said colored layer is 2 Å or more and 3 μm or less.

4. A transmissive screen according to claim 1, wherein said light-permeable sheet is formed from polycarbonate or acrylic resin.

5. A transmissive screen according to claim 1, wherein the coloring agent employed in said colored layer is dye.

6. A transmissive screen according to claim 1, wherein said light-permeable sheet is a microlens array sheet in which a plurality of convex microlenses is formed on the incident light side.

7. A transmissive screen according to claim 1, wherein both sides of said light-permeable sheet are substantially flat.

8. A display device employing the transmissive screen according to claim 1.
